(19) United States
(12) Patent Application Publication
(10) Pub. No.: US 2026/0195307 A1
(43) Pub. Date: Jul. 9, 2026

(54) Method And System For Anomaly Management In A Storage Environment

(71) Applicant: NetApp, Inc., San Jose, CA (US)

(72) Inventors: Ankit Kumar Sood, Bangalore (IN); Saket Kumar Sinha, Bangalore (IN)

(73) Assignee: NetApp, Inc., San Jose, CA (US)

(21) Appl. No.: 19/014,856

(22) Filed: Jan. 9, 2025

(51) Int. Cl. G06F 16/215; G06F 16/23

(52) U.S. Cl. CPC G06F 16/215; G06F 16/2365

(57) ABSTRACT

Systems, methods, and software are disclosed herein relating to processing telemetry data of a storage environment for anomaly detection in various implementations. In an implementation, a computing apparatus detects a sequence of missing data in telemetry data associated with a user of a data storage environment and verifies the user was active during a time period of the sequence of missing data. Upon verification, the computing apparatus generates synthetic data to replace the sequence of missing data; the synthetic data is based on activity data of users similar to the given user. The computing apparatus generates augmented data with the telemetry data and the synthetic data and incorporates the augmented data into a historical user activity profile. The computing apparatus detects anomalous behavior in the storage environment based on a comparison of new telemetry data with the historical user activity profile and takes corrective action associated with the anomalous behavior.

### TECHNICAL FIELD

Aspects of the disclosure are related to the field of storage environments and anomaly management.

### BACKGROUND

Maintaining the integrity of complex computing environments requires monitoring such environments for operational issues such as performance degradation, component failures, security breaches, compliance issues, and so on. In complex computing environments such as cloud storage networks, monitoring systems continually receive and analyze telemetry data from the many different components, devices, and interfaces of the storage environment. For example, data relating to user activity in the storage environment may be monitored to detect security breaches such as malware or ransomware attacks or other malfeasance.

Given the volume of telemetry data that is collected, there may be times when a monitoring system of a storage environment does not receive expected data for a user when the user is active in the storage environment. In the absence of the user data, the monitoring system may erroneously flag anomalous behavior in the data or fail to identify a genuine anomaly.

Continuous efforts are being made to develop technology to better manage anomalies in storage environments.

### Overview

Technology is disclosed herein for systems and methods relating to processing telemetry data of a storage environment for anomaly detection in various implementations. In one example, a computing apparatus comprising one or more computer readable storage media; one or more processors operatively coupled with the one or more computer readable storage media; and program instructions stored on the one or more computer readable storage media that, when executed by the one or more processors, direct the computing apparatus to at least detect a sequence of missing data in telemetry data associated with a given user of a data storage environment; verify the given user was active during a time period of the sequence of missing data; upon verification, generate synthetic data to replace the sequence of missing data, wherein the synthetic data is based on activity data of users similar to the given user; generate augmented data with the telemetry data and the synthetic data; incorporate the augmented data into a historical user activity profile providing an indication of expected user behavior; detect anomalous behavior in the data storage environment based on a comparison of new telemetry data with the historical user activity profile; and take automated corrective action associated with the anomalous behavior.

In another example, a method executed by one or more processors comprises detecting a sequence of missing data in telemetry data associated with a given user of a data storage environment; verifying the user was active during a time period of the sequence of missing data; upon verification, generating synthetic data to replace the sequence of missing data, wherein the synthetic data is based on activity data of users similar to the given user; generating augmented data with the telemetry data and the synthetic data; incorporating the augmented data into a historical user activity profile providing an indication of expected user behavior; detecting anomalous behavior in the data storage environment based on a comparison of new telemetry data with the historical user activity profile; and taking automated corrective action associated with the anomalous behavior.

In another example, one or more computer readable storage media having program instructions stored thereon that, when executed by one or more processors, direct a computing apparatus to at least detect a sequence of missing data in user activity data associated with a given user of a cloud storage environment; verify the given user was active during a time period of the sequence of missing data; upon verification, generate synthetic data to replace the sequence of missing data, wherein the synthetic data is based on activity data of user similar to the given user; generate augmented data with the telemetry data and the synthetic data; incorporate the augmented data into a historical user activity profile providing an indication of expected user behavior; detect anomalous behavior in the data storage environment based on a comparison of new telemetry data with the historical user activity profile; and take automated corrective action associated with the anomalous behavior.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for anomaly management in a cloud storage environment in an implementation.

FIGS. 2A and 2B illustrate methods for anomaly management in a cloud storage environment in an implementation.

FIG. 3 illustrates an operational scenario for anomaly management in a cloud storage environment in an implementation.

FIGS. 4A and 4B illustrate workflows for anomaly management in an implementation.

FIGS. 5A and 5B depict graphs of user activity data of a cloud storage environment in a process of anomaly detection in an implementation.

FIG. 6 illustrates a process of anomaly detection of user activity data of a cloud storage environment in an implementation.

FIG. 7 illustrates an operating environment according to various implementations of the present disclosure.

FIG. 8 illustrates a computing system suitable for implementing the various operational environments, architectures, processes, scenarios, and sequences discussed below with respect to the other Figures.

### DETAILED DESCRIPTION

Systems for monitoring complex computing environments often include tools for collecting and analyzing telemetry data, such as user activity data, which can be used to detect anomalies such as data breaches, cyberattacks, software malfunctions, and so on. Given the volume of data which can be produced in a complex computing environment, errors may occur during data collection which cause some of the user activity data to be lost. This data loss can lead to erroneous indications in monitoring systems, such as flagging an anomaly when none has occurred or, worse, failing to detect an anomaly.

To address the problem of the absence of user data, statistical methods may be used to replace the missing data to prevent the erroneous indications. For example, the last seen data before the data gap is replicated to replace the missing data. Alternatively, a regression or spline curve may be fit between the data values on either end of a data gap to estimate the missing values. In still other scenarios, the missing values are replaced by values predicted by a probability distribution function based on past user data. However, these methods replace the missing data with values which are only somewhat better than simple random selection. Moreover, these methods fail to account for patterns of activity in the data. Thus, these methods may still yield a high rate of false positive or false negative indications.

Various implementations are disclosed herein for processing telemetry data of a given user of a data storage environment for detecting anomalous behavior. In data storage environments, telemetry data is captured and analyzed against historical data to identify anomalous behavior which may indicate a component failure, a cybersecurity infiltration, performance issue, compliance violation, or other issue requiring intervention. For example, a monitoring program may receive telemetry data from a storage environment to detect and identify anomalies as they arise in the system. The telemetry data captured by agents in the storage environment may include data relating to user activity in the environment. (As used herein, the term “user” can include a user identity, account, or login of the data storage environment; user activity data may include metadata which identifies the user account or login associated with the activity.) User activity can include file access (e.g., file operations such as read, write, copy, delete) and other interaction with the storage environment; telemetry data for user activity may relate to the quantity or volume of such activity over time. Monitoring such data as it is captured and reported can reveal deviations from normal, historical activity which should be investigated, potentially leading to early intervention of an anomaly.

As telemetry data is captured and reported by reporting agents or data collectors at various nodes in the data storage environment, gaps may arise in the telemetry data. In some cases, a gap may be due simply to a given user not being active in the storage environment.

However, occasionally an interval of activity may not be captured or may be captured and lost due to a breakdown in a reporting pipeline. When such a breakdown occurs, the telemetry data may have several milliseconds, seconds, or even minutes during which no activity data for a given user is available. When the telemetry data has a gap in the data, anomaly detection processes may return erroneous (e.g., false positive or false negative) indications.

In an implementation, when a gap is detected in telemetry data relating to activity of a given user account (“user”), the missing data (having been identified as due to a failure in the reporting pipeline and not due to an actual absence of activity) is replaced by synthetic data generated based on activity data of other users in the data storage environment who have been identified as exhibiting similar patterns of activity in the environment. To identify users with similar activity patterns, the historical user activity data for each of the users are scored for similarity. Based on the similarity scores, clusters of similar users are identified. When a gap is detected in the user activity data of a given user, the missing data is replaced by synthetic data generated based on the activity of other users in the cluster of the given user. For example, the synthetic data may be computed based on an average (e.g., mean) of the corresponding user activity data of other users in the cluster. The synthetic data is used to fill in the gap; the user telemetry data augmented with the synthetic data then serves as a benchmark to analyze user activity data for anomalous behavior. In other words, to detect anomalous behavior, historical user activity data including the augmented telemetry data can be used to identify data values in recent or real-time user activity which fall outside the pattern of historical user activity.

In various implementations, telemetry data for understanding user activity in a data storage environment includes time logs of file access and operations such as read, write, delete, and share events. User activity data may also include metrics for particular types of activity over time, such as the number of file uploads, downloads, edits, deletions, etc., and shares a user performs within a given period. In some scenarios, user behavior activity includes quantities such as the amount of data transferred or bandwidth usage over time. User activity data may also track the number of access attempts, file versions created, and so on over time.

Anomalous behavior related to the volume of user activity in a cloud storage environment may involve significant deviations from normal usage patterns. Such deviations can include sudden spikes in activity volume or an increase in activity concentrated over a short period. For example, analysis of user activity data detecting unusually high traffic or bandwidth consumption for a single user account may signal data exfiltration, especially if the volume far exceeds the typical range of such activity. Similarly, excessive file access or mass transfers may indicate automated scripts or malicious actors attempting to gather large amounts of data.

Deviations from normal usage can also include low-volume activity potentially indicating account compromise, evasion techniques, or even ransomware attacks.

Technical effects of the technology disclosed herein include improved anomaly detection in user activity data whereby corrective action can be taken when an anomaly is detected. The failure to quickly detect and take corrective action when an anomaly occurs can lead to a range of negative consequences, including unauthorized access to sensitive systems or data, financial losses due to fraudulent activity, and operational disruptions that compromise service availability or quality. For example, in the time that a hacked or compromised user access is not detected and cut off, malicious actors can exploit vulnerabilities, exfiltrate confidential information or cause widespread damage to the computing environment. The technology disclosed herein enables rapidly identifying and responding to anomalies to mitigate such risks.

Various embodiments of the present technology provide for a wide range of technical effects, advantages, and/or improvements to computing systems and components. For example, various embodiments may include one or more of the following technical effects, advantages, and/or improvements: 1) unconventional and non-routine operations to telemetry data analysis; 2) dynamic integration of similarity and clustering techniques to telemetry data analysis; and/or 3) use of gap filling to improve the accuracy of data analytics. Some embodiments include additional technical effects, advantages, and/or improvements to computing systems and components.

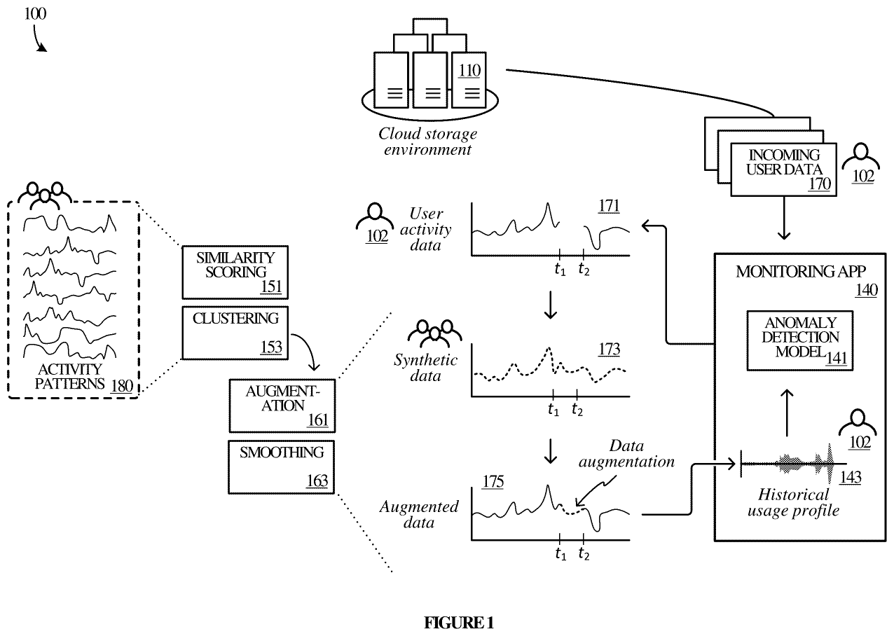

Turning now to the Figures, FIG. 1 illustrates operational environment 100 for anomaly detection and management in an implementation. Operational environment 100 includes cloud storage environment 110 producing incoming user data 170 for user 102 which is received by monitoring application 140. Monitoring application 140 includes anomaly detection model 141 and historical usage profile 143. Operational environment 100 also includes similarity scoring module 151, clustering module 153, augmentation module 161, and smoothing module 163. Operational environment 100 also includes user activity data 171, synthetic data 173, augmented data 175, activity patterns 180, and user 102 of cloud storage environment 110.

Cloud storage environment 110 is representative of a cloud-based data storage network or environment including a virtualized storage infrastructure by which clients store, manage, and access data using remote servers hosted by a cloud service provider. In cloud storage environment 110, data may be stored in distributed locations, ensuring redundancy, scalability, and accessibility from various devices and geographic locations. Users may interact with cloud storage environment 110 via wired or wireless network connectivity and web interfaces, application programming interfaces (APIs), or sync tools, and user activity and file operations such as uploads, downloads, sharing, and modifications are tracked through detailed telemetry data.

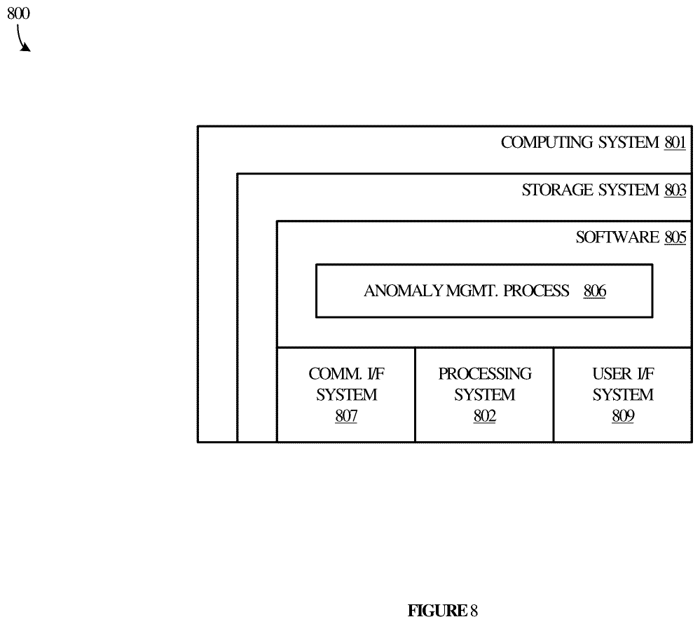

Monitoring application 140 is representative of a functionality implemented in software or hardware for monitoring, managing, and optimizing storage systems including on-premises, hybrid cloud, public cloud, and other cloud storage environments. Monitoring application 140 may include functionality to detect anomalous behavior based on telemetry data captured by data collectors in the storage environment and to identify anomalies as they arise. In various implementations, monitoring application 140 hosts a user interface on a computing device (not shown), of which computing device 800 of FIG. 8 is representative, by which a user or operator of a cloud storage environment can monitor telemetry to detect abnormal or anomalous behavior which may signal a more serious event, such as a component failure or security breach. In various implementations, monitoring application 140 receives and monitors telemetry data including user activity data captured by agents at various nodes of a cloud storage environment.

Anomaly detection model 141 is representation of a functionality implemented in software or hardware for receiving and analyzing telemetry data from a cloud storage environment to detect anomalous behavior. Anomaly detection model 141 may include functionality for detecting anomalous behavior in telemetry data, such as user activity data, based on comparing telemetry captured in real-time or near real-time to historical telemetry data, such as historical usage profile 143, for a particular user of the cloud storage environment (e.g., user 102) in a process of unsupervised learning. Historical usage profile 143 provides an indication of expected behavior or activity for user 102. For example, anomaly detection model 141 may be a statistical model which identifies anomalous behavior based on historical usage profile 143. Anomaly detection model 141 may also be a machine learning or deep learning model or neural network architecture trained on historical usage profile 143.

Similarity scoring module 151 is representative of a functionality implemented in software or hardware for scoring telemetry data from a cloud storage environment for similarity. Similarity scoring module 151 may include functionality for generating a metric which quantifies the similarity of sets of telemetry data, such as user activity data. Similarity scoring module 151 may execute an algorithm based on Dynamic Time Warping (DTW) or other similarity scoring methods to generate similarity scores for the data sets. Various types of DTW similarity scoring which may be executed by similarity scoring module 151 include pairwise DTW, groupwise DTW, center-star DTW, DTW Barycenter Averaging (DBA), and the like. In some scenarios, similarity scoring module 151 generates similarity scores based on Fourier transformations of the user activity data.

Clustering module 153 is representative of a functionality implemented in software or hardware for clustering sets of telemetry data based on the similarity of the sets. Clustering module 153 may include functionality for identifying clusters of data sets comprising user activity data by similarity, such as based on a similarity score of the data sets generated by similarity scoring module 151. Clustering module 153 may execute an Ordering Points To Identify the Clustering Structure (OPTICS) process for identifying clusters of similar data sets. In some implementations, clustering module 153 may execute a hierarchical, K-means, or Density-Based Spatial Clustering of Applications with Noise (DBSCAN) process or algorithm for identifying clusters of similar data sets.

Augmentation module 161 is representative of a functionality implemented in software or hardware for augmenting telemetry data, such as user activity data, with synthetic data. For example, augmentation module 161 may replace sequences of missing data values in the user activity data of a given user with synthetic data generated from activity data of users who are similar to the given user for the period of time corresponding to the missing data. Smoothing module 163 is representative of a functionality implemented in software or hardware for smoothing synthetic data that is generated based on telemetry data such as user activity data. For example, smoothing module 163 may apply a Gaussian filter to smooth jumps or discontinuities in user activity data that arise when user activity data has been augmented by synthetic data.

Incoming user data 170 is representative of telemetry data comprising time-series data of user activity captured in real-time or near real-time for user 102 associated with cloud storage environment 110. Incoming user data 170 may be captured or recorded by agents at various nodes of the cloud storage environment and reported to an application such as monitoring application 140. Incoming user data 170 may include time-series datasets which track a quantity of user activity in the cloud storage environment as a function of time. Incoming user data 170 which is determined to not have any missing data values may be directly incorporated into historical usage profile 143 for anomaly detection of future user data.

User activity data 171 is representative of telemetry data of incoming user data 170 comprising time-series data of user activity for a given user of cloud storage environment 110, i.e., user 102, captured in real-time or near real-time in a cloud storage environment but which includes a sequence of missing data. As illustrated in FIG. 1, user activity data 171 includes a sequence of missing data values, e.g., from time t₁ to time t₂.

Activity patterns 180 are representative of sets of historical telemetry data comprising time-series data of user activity captured by agents or data collectors in a cloud storage environment with each set representative of the historical activity of a particular user. The time-series data of user activity may include metrics which quantify user access to data (e.g., files) stored in the cloud storage environment over an interval time, but may also include metrics relating to bandwidth consumption, login attempts and failures, and other telemetry captured for a given user. In some scenarios, activity patterns 180 include time-aggregated user activity data, e.g., user activity data which has been aggregated by averaging each minute of data values, for example, by averaging data for the corresponding minutes of several days'worth of data.

In a brief operational scenario of operational environment 100, monitoring application 140 receives incoming user data 170 of user 102 and executes anomaly detection model 141 for automatically detecting anomalous behavior. As an example, anomaly detection model 141 compares the incoming data to historical usage profile 143 of user 102. If anomaly detection model 141 detects a significant deviation between incoming user data 170 and historical usage profile 143, the deviation is flagged as indicating anomalous behavior.

Continuing with the brief operational scenario, historical usage profile 143 is based on a set of user activity data that has been captured and for which an activity pattern or profile has been derived. The activity profile may be the aggregate or average of selected activity data for user 102, such as several datasets or days'worth of activity data. As incoming user data 170 continues to be collected, this information is added to or incorporated in historical user activity data. However, if incoming user data 170 is found to have missing data, as in user activity data 171, this can cause anomaly detection model 141 to produce erroneous indications (e.g., false positive or false negative indications). In the case of a false negative indication, the failure to detect an anomaly or to quickly detect an anomaly can lead to, for example, a breach of sensitive or confidential information by an undetected unauthorized access or service disruption due to an undetected failure in the system. To remunerate user activity data 171, monitoring application 140 generates synthetic data 173 to replace the missing data values based on user activity data of other, similar users of cloud storage environment 110 for the time period corresponding to the missing data (i.e., from t₁ to t₂).

To generate synthetic data 173, monitoring application 140 identifies clusters of similar users of cloud storage environment 110 based on activity patterns 180. To identify clusters of similar users, monitoring application 140 executes similarity scoring module 151 which generates similarity scores for each of activity patterns 180 using DTW. With each of activity patterns 180 scored for similarity, monitoring application 140 executes clustering module 153 to identify clusters of similar users based on the similarity scores using OPTICS.

With clusters of similar users of cloud storage environment 110 identified, monitoring application 140 receives user activity data 171 for user 102 of cloud storage environment 110.

As illustrated, user activity data 171 includes a gap in the data values for an interval of time from t₁ to t₂. Monitoring application 140 determines that the gap is not due to user inactivity; therefore, the gap is attributed to a failure of user activity data to be captured or transmitted to monitoring application 140. To determine the gap is not due to user inactivity, monitoring application 140 may detect activity in a second stream of telemetry data associated with the user. For example, monitoring application 140 may detect user activity from network-level data such as HTTP (Hypertext Transfer Protocol) requests, DNS (Domain Name Server) queries, or TCP/IP (Transmission Control Protocol/Internet Protocol) connections from the user's device within cloud storage environment 110.

To process user activity data 171 to prevent faulty anomaly indications due to the gap, monitoring application 140 generates synthetic data to fill the gap based on historical activity data of users identified as similar to the historical activity of user 102, i.e., other users in the cluster to which user 102 belongs. Monitoring application 140 generates synthetic data 173 based on the user activity data of the other users in user 102's cluster. For example, synthetic data 173 may be an average of the activity data of the other users for the same period of time as user activity data 171 or, more specifically, for the same period of time as the missing data (from t₁ to t₂). Next, monitoring application 140 replaces the sequence of missing values with the corresponding values of synthetic data 173, yielding augmented data 175. Augmented data 175 includes user activity data 171 supplemented with the portion of synthetic data 173 for the period of time from t₁ to t₂. In supplementing user activity data 171 with the portion of synthetic data 173, monitoring application 140 may execute smoothing module 163 to apply a Gaussian filter to the data to smooth any abrupt jumps or irregularities in a neighborhood of and within the augmented portion.

With user activity data 171 now including a full complement of data based on the augmentation with synthetic data 173 (depicted as augmented data 175), monitoring application 140 incorporates augmented data 175 into historical usage profile 143 for understanding incoming user data 170 for anomalies. Anomaly detection model 141 compares incoming user data 170 to historical usage profile 143, including augmented data 175, to identify anomalous data. Historical usage profile 143 to which incoming user data 170 is compared may include historical user activity data for the given user (user 102), such as a range or variance of user activity over time. If at any time incoming user data 170 exceeds the variance of historical usage profile 143, anomaly detection model 141 flags the data for anomalous behavior. Based on the flagging, monitoring application 140 may report the anomalous behavior in the user interface of the application or initiate other actions to investigate or address the anomalous behavior. When anomalous behavior is detected, cloud storage environment 110 may automatically initiate corrective action, such as restricting or revoking access or permissions associated with user 102, initiating a data snapshot or backup, isolating systems which may have been vulnerable to a malicious infiltration, implementing higher-level authentication (e.g., two-factor authentication) for user 102, initiating a broader examination or audit of activity data for user 102, and so on.

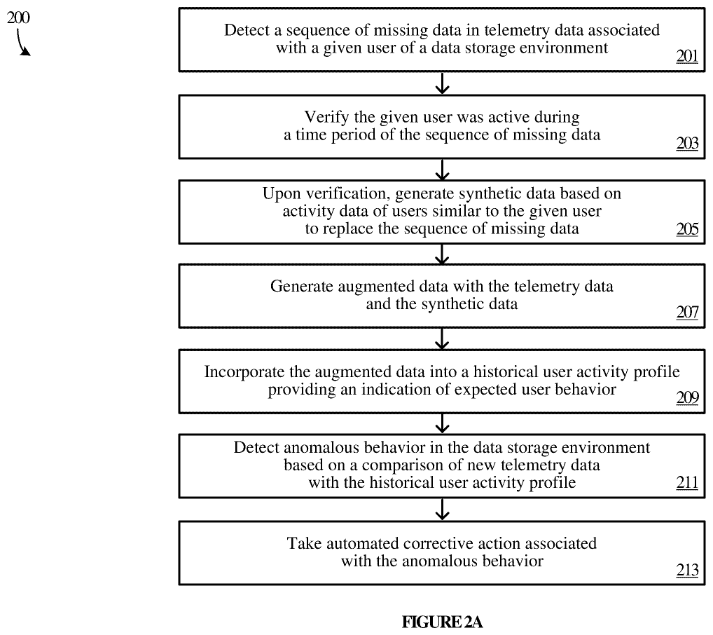

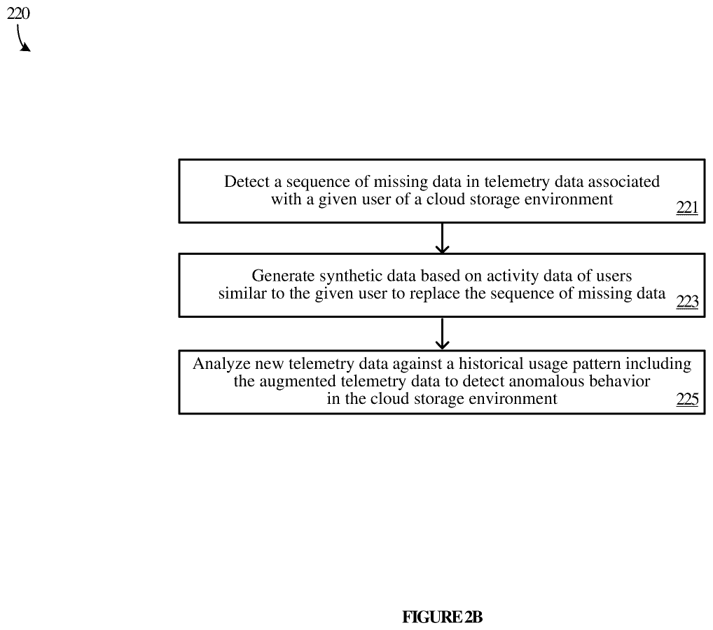

FIGS. 2A and 2B illustrate methods for telemetry data processing for anomaly detection in an implementation, herein referred to as processes 200 and 220. Process 200 of FIG. 2A may be implemented in program instructions in the context of any of the software applications, modules, components, or other such elements of one or more computing devices. The program instructions direct the computing device(s) to operate as follows, referred to in the singular for the sake of clarity.

In process 200, a computing device detects a sequence of missing data in telemetry data associated with a given user of a data storage environment (step 201). In an implementation, a computing device receives telemetry data associated with the activities of each of multiple users of a data storage environment, such as a cloud storage environment, off-premises storage environment, on-premises storage environment, or hybrid storage environment. The user activity data of a given user may be a metric (e.g., number or volume) of actions or activity associated with the user as it is captured over time. To understand user activity data (for example, for anomaly detection) of a given user, the computing device may compute a representative value of the user activity data for specified intervals of time. For example, the computing device may compute an aggregation per minute of the user activity data for each minute of data, generating a time-series data set of aggregated activity values by the minute which will be examined for anomalous behavior. The time-series data sets may also be segmented into daily sets or patterns of activity, ranging from, for example, the 0th minute (0:00 AM) to the 1440th minute (11:59 PM) of a given day, and any subsequent comparisons may be performed with respect to daily activity. In some scenarios, the time-series data sets by day may be further categorized according to the day of the week, weekday, weekend, or holiday so that user activity which may be atypical for procedural reasons can be excluded from the subsequent analysis.

As the time-series data is generated based on the incoming telemetry data for each user, the computing device may identify, for the given user, that there is a sequence of values for which user activity data is missing, e.g., non-existent (“NaN”) or zero. For example, the time-series data of mean activity values may include several minutes of apparent inactivity. The computing device determines that the user was in fact active during the period of apparent inactivity, however, the user activity data is lost, e.g., due to an error in the data pipeline.

The computing device verifies the user is active during a time period of the sequence of missing data (step 203). In an implementation, the computing device compares the user activity data with a second stream of telemetry data for the same time period as the missing data and confirms that the existence of activity in the second stream. In some scenarios, the computing device may verify the user was active during the time period by accessing system logs which record logins, authentications, or other information associated with a user account activity.

Upon verification, the computing device generates synthetic data based on activity data of user similar to the given user to replace the sequence of missing data (step 205). Having verified that the user was indeed active during the time period of the missing data, the computing device determines that the data is missing due to a fault or error in the telemetry data pipeline. The computing device proceeds with generating synthetic data based on the user activity data of other users who have been identified as having, historically, similar activity patterns as the user.

To generate synthetic data, the computing device identifies a cluster of users which includes the given user and who have exhibited activity patterns that are similar to each other based on their historical user activity data. To identify the cluster of users for the given user, the computing device generates similarity scores for the historical user activity of the users of the cloud storage environment. The similarity scores may be based on a conceptual distance between the data values of the user activity such that the score reflects the similarity of the patterns of activity of two or more users. The conceptual distance may be, for example, a DTW distance or Euclidean distance between two sets of user activity data.

In various implementations, the computing device computes a DTW matrix of similarity scores representative of a DTW distance from each user's historical activity data to the historical activity data of every other user of the cloud storage environment. Based on the DTW matrix, the computing device determines clusters of users whose historical activity patterns are similar to each other. Thus, the computing device can infer information about the given user's missing activity data based on the activity of other users in the given user's cluster.

In an implementation, to generate synthetic data values for the missing data, the computing device averages the user activity data of the other users in the given user's cluster.

For example, if the sequence of missing values occurs between the 800th minute and the 920th minute of a given data set, the corresponding data values for each of the users in the cluster are averaged to generate a set of synthetic data values to replace or stand in for the missing the data. The data sets selected for generating the synthetic data may be the user activity data for the same day as the missing data. In an implementation, the synthetic data is computed for the missing interval of data (e.g., the missing 120 minutes of data), or synthetic data is generated for the day and a portion corresponding to the missing interval is selected to replace the missing data.

The computing device generates augmented data with the telemetry data and the synthetic data (step 207). In an implementation, to replace the sequence of missing values with the corresponding synthetic data, the computing device generates an augmented data set which includes the original time-series data set of the given user augmented with the synthetic data. To remunerate the missing values, for each data point of the sequence of missing data, the data point is assigned the corresponding value from the synthetic data.

The computing device incorporates the augmented data into a historical user activity profile providing an indication of expected user behavior (step 209). For example, the augmented data set may be incorporated in an activity pattern or profile for the user which has been generated based on a statistical analysis of the data, e.g., computing mean, deviation, variance values according to time for the time-series data. The historical user data provides an indication of the user's expected behavior based on the data reflecting his/her past behavior such that when a deviation from the expected behavior is detected, the deviation may be flagged as an anomaly.

The computing device detects anomalous behavior in the data storage environment based on a comparison of new telemetry data with the historical user activity profile (step 211). In an implementation, the computing device uses recently collected time-series data of user activity to detect anomalous behavior in the data storage environment by identifying points in time at which the volume of user activity exceeds a threshold. To analyze the time-series data, the computing device compares the data to an activity pattern or profile based on historical usage data of the given user, where the historical usage data includes the user activity data augmented with the synthetically generated replacement data. For example, the activity profile may be the range of the daily historical usage data for each minute of the day, where the range is determined by the mean values plus/minus the variance. In comparing the time-series data of user activity to the activity profile, the computing device identifies any points in time at which the user activity falls outside of the corresponding range indicating in the profile. The points in time where the activity profile is exceeded are flagged as anomalous behavior.

In some scenarios, the historical user activity profile is provided as training data for an anomaly detection model in a process of unsupervised learning. For example, a Recurrent Neural Network (RNN), such as a Long Short-Term Memory (LSTM) model or a Gated Recurrent Unit (GRU) model, may be trained for data reconstruction or prediction. The model may be trained on historical time-series data which provides an indication of the user's expected behavior. The historical data may be segmented (e.g., via a sliding window) into sequences which are fed into the model as input. Once trained, the model processes incoming sequences of new user activity data and computes reconstruction or prediction errors at each time step. Anomalies are identified when the computed errors exceed a predefined threshold indicating that the new data is deviating beyond a threshold amount from behavior predicted by the model in accordance with its training.

The computing device takes automated corrective action associated with the anomalous behavior (step 213). When anomalous behavior is detected in the new telemetry data, in an implementation, the computing device initiates one or more actions to protect any potentially affected systems. Such actions can include siloing the potentially affected systems, taking a snapshot of the potentially affected systems, transmitting a notification of the detection to data security entities of the storage environment to initiate an investigation, and so on. The computing device may also initiate corrective actions with respect to the user or the user account exhibiting the anomalous conduct, such as revoking the user's access to the storage environment or heightening authentication requirements (e.g., two-factor authentication) for access. The computing device may also flag the user activity data exhibiting the anomaly to prevent it from being incorporated into the historical user activity profile.

As with process 200, process 220 of FIG. 2B may be implemented in program instructions in the context of any of the software applications, modules, components, or other such elements of one or more computing devices. The program instructions direct the computing device(s) to operate as follows, referred to in the singular for the sake of clarity.

In process 220, the computing device detects a sequence of missing data in telemetry data associated with a given user of a cloud storage environment (step 221). In an implementation, a computing device receives telemetry data associated with the activities of each of multiple users of a cloud storage environment. The user activity data of a given user may be a number or volume of actions or activity associated with the user as it is captured over time. To understand user activity data (for example, for anomaly detection) of a given user, the computing device may compute a representative value of the user activity data for specified intervals of time. For example, the computing device may compute the aggregate of the user activity data for each minute of data, generating a time-series data set of aggregated activity values by the minute for the subsequent analysis. The time-series data sets may also be segmented into daily patterns of activity, ranging from, for example, the 0th minute (0:00 AM) to the 1440th minute (11:59 PM) of a given day, and any subsequent comparisons may be performed with respect to daily activity. In some scenarios, the time-series data sets by day may be further categorized according to the day of the week, weekday, weekend, or holiday so that user activity which may be atypical for procedural reasons can be excluded from the subsequent analysis.

As the time-series data is generated based on the incoming telemetry data for each user, the computing device may identify, for the given user, that there is a sequence of values for which user activity data is missing, e.g., non-existent (“NaN”) or zero. For example, the time-series data of mean activity values may include several minutes of apparent inactivity. The computing device determines that the user was in fact active during the period of apparent inactivity, however, the user activity data is lost, e.g., due to an error in the data pipeline.

The computing device generates synthetic data based on activity data of users similar to the given user to replace the sequence of missing data (step 223). In an implementation, to prevent the anomaly detection or other analysis from throwing erroneous flags or indicators based on the absence of the data, the computing device backfills the user data with synthetic data derived from the activity data of other, similar users.

To generate synthetic data, the computing device identifies a cluster of users which includes the given user and who have exhibited activity patterns that are similar to each other based on their historical user activity data. To identify the cluster of users for the given user, the computing device generates similarity scores for the historical user activity of the users of the cloud storage environment. The similarity scores may be based on a conceptual distance between the data values of the user activity such that the score reflects the similarity of the patterns of activity of two or more users. The conceptual distance may be, for example, a DTW distance or Euclidean distance between two sets of user activity data.

In various implementations, the computing device computes a DTW matrix of similarity scores representative of a DTW distance from each user's historical activity data to the historical activity data of every other user of the cloud storage environment. Based on the DTW matrix, the computing device determines clusters of users whose historical activity patterns are similar to each other. Thus, the computing device can infer information about the given user's missing activity data based on the activity of other users in the given user's cluster.

In an implementation, to generate synthetic data values for the missing data, the computing device averages the user activity data of the other users in the given user's cluster. For example, if the sequence of missing values occurs between the 800th minute and the 920th minute of a given data set, the corresponding data values for each of the users in the cluster are averaged to generate a set of synthetic data values to replace or stand in for the missing the data. The data sets selected for generating the synthetic data may be the user activity data for the same day as the missing data. In an implementation, the synthetic data is computed for the missing interval of data (e.g., the missing 120 minutes of data), or synthetic data is generated for the day and a portion corresponding to the missing interval is selected to replace the missing data.

In an implementation, to replace the sequence of missing values with the corresponding synthetic data, the computing device generates an augmented data set which includes the original time-series data set of the given user augmented with the synthetic data. The computing device may then incorporate the augmented data set into historical user activity data for the given user for anomaly analysis. For example, the augmented data set may be incorporated in an activity pattern or profile generated based on a statistical analysis of the data, e.g., computing mean, deviation, variance values according to time for the time-series data.

The computing device uses new telemetry data against a historical usage pattern including the augmented telemetry data to detect anomalous behavior in the cloud storage environment (step 225). In an implementation, the computing device analyzes recently collected time-series data of user activity to detect anomalous behavior by identifying points in time at which the volume of user activity exceeds a threshold. To analyze the time-series data, the computing device compares the data to an activity pattern or profile based on historical usage data of the given user, where the historical usage data includes the user activity data augmented with the synthetically generated replacement data. For example, the activity profile may be the range of the daily historical usage data for each minute of the day, where the range is determined by the mean values plus/minus the variance. In comparing the time-series data of user activity to the activity profile, the computing device identifies any points in time at which the user activity falls outside of the corresponding range indicating in the profile. The points in time where the activity profile is exceeded are flagged as anomalous behavior.

When anomalous behavior is detected, the computing device may perform a number of actions to address the indication. The computing device may display an indication of the anomaly in a user interface of the monitoring application including indicating the user exhibiting the anomalous behavior. The computing device may also initiate other actions for addressing the anomalous behavior such as limiting access of the given user to the cloud storage environment until the anomaly is resolved.

Referring again to FIG. 1, operational environment 100 illustrates processes 200 and 220 in an implementation with reference to elements of operational environment 100. In operational environment 100, monitoring application 140 executing on one or more computing devices in association with cloud storage environment 110 receives telemetry data from cloud storage environment 110, such as from agents which generate telemetry data based on tracking user activity within cloud storage environment 110. The telemetry data includes activity patterns 180 from historical user activity data of various users of cloud storage environment 110. Based on activity patterns 180, monitoring application 140 identifies clusters of users who exhibit similar patterns of behavior or activity in cloud storage environment 110. To identify clusters of similar users, monitoring application 140 executes similarity scoring module 151 to generate similarity scores for activity patterns 180 which quantify the similarity of the individual patterns with respect to each of the other patterns. In an implementation, similarity scoring module 151 computes a matrix of DTW distances for each activity pattern with respect to each of the others of activity patterns 180. Based on the similarity scores in the DTW matrix, monitoring application 140 executes clustering module 153 which identifies clusters of similar users based on the similarity scores. In an implementation, clustering module 153 executes an OPTICS algorithm to identify the clusters.

Monitoring application 140 receives and processes telemetry data of cloud storage environment 110 to detect anomalies in cloud storage environment 110. In an implementation, monitoring application 140 generates user activity data 171 based on the incoming telemetry data associated with user 102. To generate user activity data 171, monitoring application 140 computes, for each day's worth of data, a time-series data set of the aggregated values of the telemetry data, such as an aggregate of user activity data for each minute of data.

Having processed or during processing of the incoming telemetry data for user 102 to generate user activity data 171, monitoring application 140 detects a sequence of missing data from time t₁ to time t₂. Monitoring application 140 determines that the sequence of missing data is not due to user 102 being inactive, for example, by consulting records of account login activity. Upon determining that the sequence of missing data is due to a breakdown in the telemetry data pipeline, monitoring application 140 proceeds with computing synthetic data to replace the missing data values.

Monitoring application 140 generates synthetic data 173 to replace the sequence of missing data. Monitoring application 140 identifies user 102 as being associated with user activity data 171 and then identifies the cluster of users to which user 102 belongs. Synthetic data 173 is generated based on user activity data of the other users in the identified cluster. To generate synthetic data 173, monitoring application 140 computes an average of the user activity data of the other users for a time period spanning time t₁ to time t₂. In some scenarios, the user activity used to generate synthetic data 173 is data captured on the same day as user activity data 171. With synthetic data 173 generated, monitoring application 140 replaces the sequence of missing data with the corresponding values of synthetic data 173, which may be all of or a portion of synthetic data 173. User activity data 171 with the replacement values of synthetic data 173 forms augmented data 175 which is incorporated into historical usage profile 143 for use by anomaly detection model 141.

Monitoring application 140 executes anomaly detection model 141 to analyze incoming user data 170 associated with user 102 for anomalous behavior. Anomaly detection model 141 compares incoming user data 170 with an activity profile of user 102 to identify times during which the user activity in incoming user data 170 exceeds the bounds of non-anomalous behavior indicated in the activity profile. The activity profile may be based on historical usage profile 143 of user 102 correlated by time. For example, the activity profile may include the mean and variance of the activity patterns of user 102 computed for each minute. When anomaly detection model 141 determines that incoming user data 170 includes one or more data values which exceed the bounds of the activity profile, anomaly detection model 141 flags the data values as anomalous. Because historical usage profile 143 includes user activity data 171 augmented with synthetic data 173, the sequence of missing data values in previously recorded user activity data 171 is effectively muted or nullified.

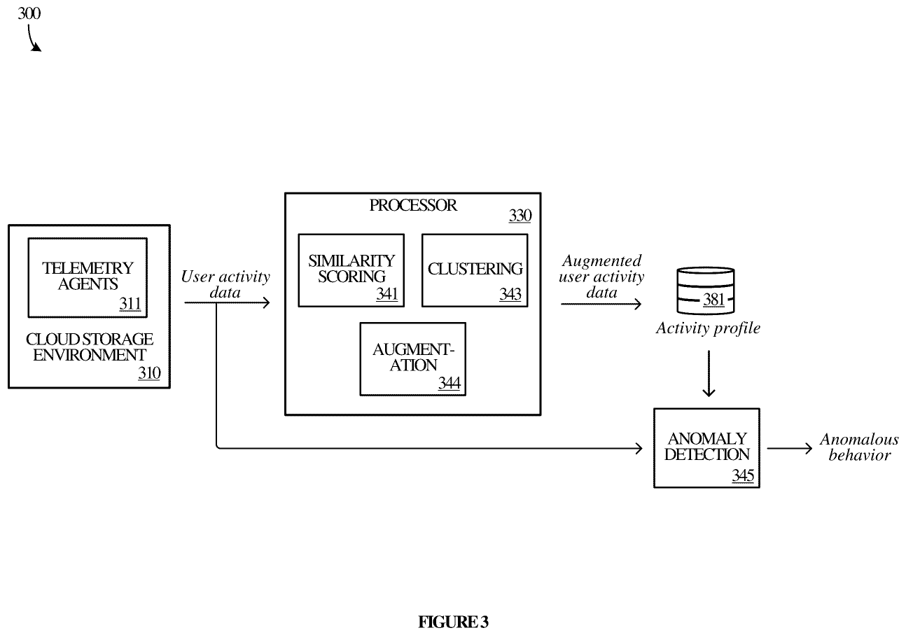

Turning now to FIG. 3, FIG. 3 illustrates operational environment 300 for telemetry data processing for anomaly detection in an implementation. Operational environment 300 includes cloud storage environment 310, processor 330, anomaly detection module 345, and activity profile 381. Cloud storage environment 310 includes telemetry agents 311. Processor 330 includes similarity scoring module 341, clustering module 343, and augmentation module 344.

Cloud storage environment 310 is representative of a cloud-based data storage network or environment including a virtualized storage infrastructure by which clients store, manage, and access data using remote servers hosted by a cloud service provider. In cloud storage environment 310, data may be stored in distributed locations, ensuring redundancy, scalability, and accessibility from various devices and geographic locations. Users may interact with cloud storage environment 310 via wired/wireless connectivity using web interfaces, APIs, or sync tools, and user activity and file operations such as uploads, downloads, sharing, and modifications are tracked through detailed telemetry data.

Telemetry agents 311 are representative of functionalities implemented in hardware or software for capturing, collecting, and reporting telemetry data of a cloud storage environment. Telemetry agents 311 may be located at various elements, interfaces, or nodes of the cloud storage environment to capture data relating to operations and performance activity including activities performed by users of the cloud storage environment.

Processor 330 is representative of a functionality implemented in hardware or software for receiving and processing user activity data received from telemetry agents 311. Processor 330 submits the processed data, such as augmented user activity data, to be incorporated into activity profile 381 for use by anomaly detection module 345.

Processor 330 includes similarity scoring module 341 which is representative of a functionality implemented in hardware or software for scoring user activity data sets of a cloud storage environment for similarity. Similarity scoring module 341 may include functionality for generating a metric which quantifies the similarity of sets of telemetry data, such as user activity data. Similarity scoring module 341 may execute an algorithm based on Dynamic Time Warping (DTW) or other similarity scoring methods to generate similarity scores for the data sets.

Processor 330 also includes clustering module 343 and augmentation module 344. Clustering module 343 is representative of a functionality implemented in hardware or software for clustering sets of user activity data based on the similarity scoring of the data sets generated by similarity scoring module 341. Clustering module 343 may execute an OPTICS process for identifying clusters of similar data sets. Augmentation module 344 is representative of a functionality implemented in hardware or software for augmented user activity data by replacing missing data values with synthetic data (i.e., data that is not original to the user activity data). Augmentation module 344 generates the synthetic replacement data based on user activity data of users similar to the user associated with user activity data to be augmented.

Anomaly detection module 345 is representation of a functionality implemented in software or hardware for receiving and analyzing telemetry data from a cloud storage environment to detect anomalous behavior. Anomaly detection module 345 may include functionality for detecting anomalous behavior in user activity data based on comparing telemetry captured in real-time or near real-time to historical user activity data, such as activity profile 381, in a process of unsupervised learning.

Activity profile 381 is representative of one or more sets of historical data of activity of a given user of cloud storage environment 310. Activity profile 381 may include user activity data organized by day and aggregated by minute. Activity profile 381 may include statistical quantities which describe user activity data such as the mean and variance values of the user activity aggregated by minute for multiple days'worth of data.

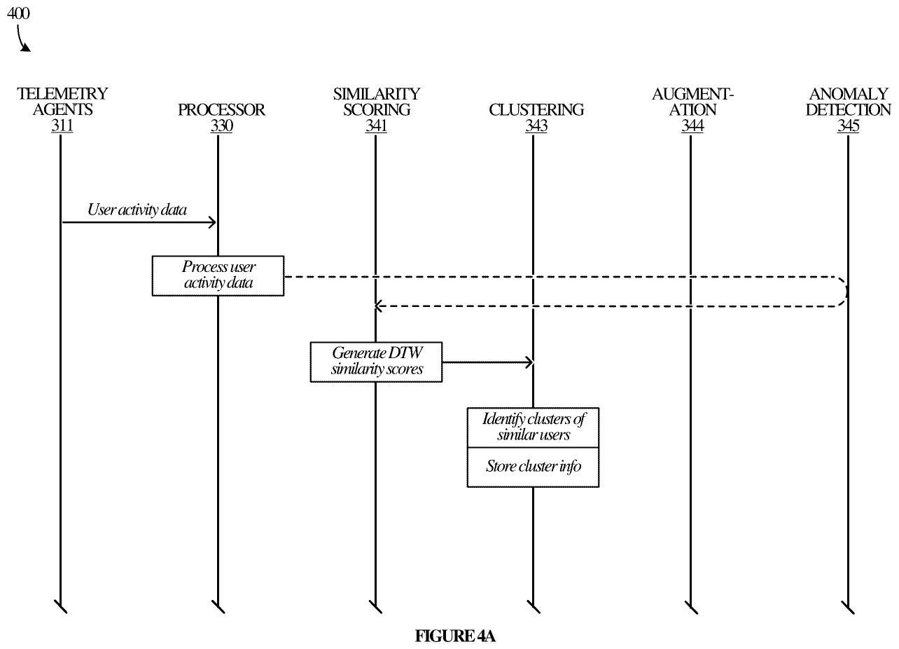

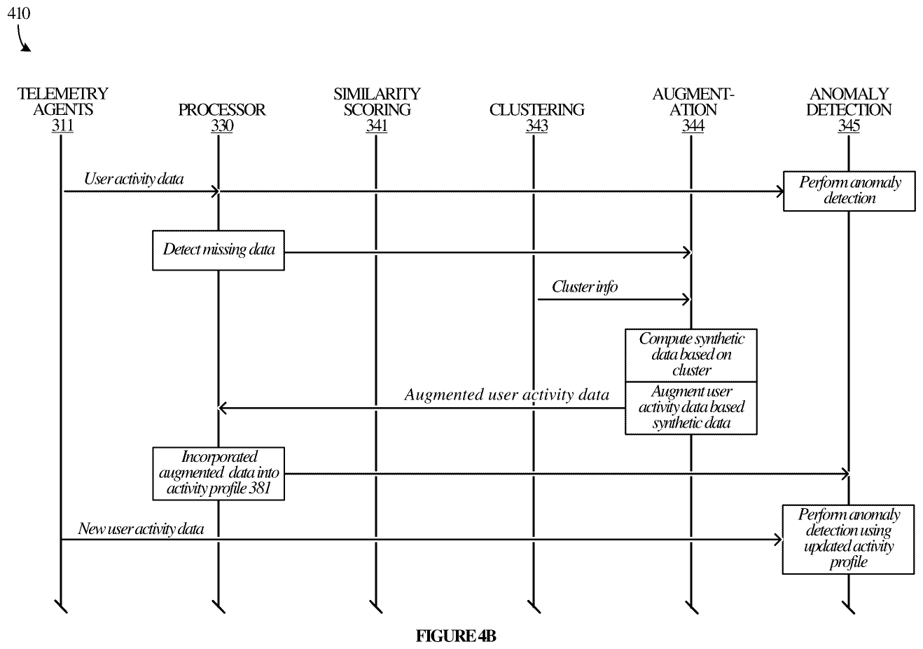

FIGS. 4A and 4B illustrate workflow 400 for identifying clusters of similar user activity data for processing user activity data and workflow 410 for processing user activity data for anomaly detection of future user activity data, respectively, in implementations referring to elements of operational environment 300.

In workflow 400, telemetry agents 311 of cloud storage environment 310 capture and transmit telemetry data to processor 330, including user activity data for multiple users of cloud storage environment 310. Processor 330 receives the user activity data and processes the data for each user to generate data sets which are aggregated by the minute. Processor 330 also segments the data values into data sets spanning a 24-hour period (e.g., 0:00 AM to 11:59 PM). In some implementations, the processed user activity data is analyzed for anomalous behavior by anomaly detection module 345 which compares the data to historical activity patterns to detect deviations from the historical patterns.

Similarity scoring module 341 of processor 330 computes a DTW matrix of similarity scores for the processed user activity data of each user of the multiple users; the similarity scores quantify the similarity of each user with respect to the other users represented in the matrix. Based on the DTW matrix of similarity scores, clustering module 343 executes an OPTICS algorithm to identify groupings or clusters of similar user activity data sets, i.e., similar users, based on the similarity scores. Clustering module 343 stores the identified clusters including the users associated with each cluster.

Continuing with workflow 410 of FIG. 4B, during the operation of cloud storage environment 310, telemetry agents 311 capture and transmit user activity data of users of cloud storage environment 310 to processor 330. The user activity data is analyzed for anomalous behavior by anomaly detection module 345. After the anomaly detection analysis, processor 330 determines that the user activity data for a given user is missing data for a period of time. Processor 330 also determines that the user was active during the period of time of the missing data. For example, processor 330 determines that a second stream of telemetry data for the given user shows activity during the same time period as the missing data.

Augmentation module 344 of processor 330 receives the user activity data of the given user and generates synthetic data to replace the missing data values. To generate the synthetic data values, augmentation module 344 identifies the other users in the cluster associated with the given user and obtains the user activity data for the other users from processor 330 for a period of time spanning the missing data. In an implementation, the synthetic data is computed based on aggregating user activity data values such that the data reflects per-minute aggregated user activity over, for example, a 24-hour period. Augmentation module 344 computes the synthetic data by averaging the user activity data of the other users for at least a period time spanning the missing data, then replaces the missing data values with the calculated averages. Augmentation module 344 returns the now-augmented user activity data for further handling.

Processor 330 incorporates the augmented user activity data into activity profile 381 for use by anomaly detection module 345. Activity profile 381 is based on historical data of the given user's activity in cloud storage environment 310. In an implementation, activity profile 381 includes a range of activity data values for every minute over a 24-hour period of time (e.g., from 0:00 AM to 11:59 PM). As anomaly detection module 345 receives new user activity data, the data is analyzed by comparing the data values to activity profile 381 updated to include the augmented user activity data. When anomaly detection module 345 identifies a data value in new user activity data which exceeds its corresponding range, anomaly detection module 345 flags the value as anomalous. In some scenarios, if the new or incoming user activity data is determined to have missing data, the new user activity data may also be augmented with synthetically generated data from similar users over the same time period (per the methods disclosed herein) prior to analysis by anomaly detection module 345 to avoid false positive/negative indications arising from the gap in the data. Subsequent to the analysis by anomaly detection module 345, the incoming data now augmented with synthetic data may be incorporated into activity profile 381 for use in analyzing future user activity data.

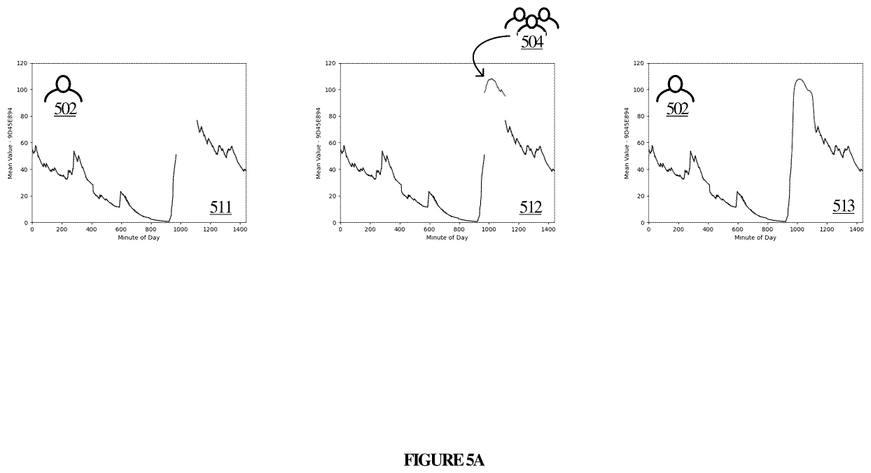

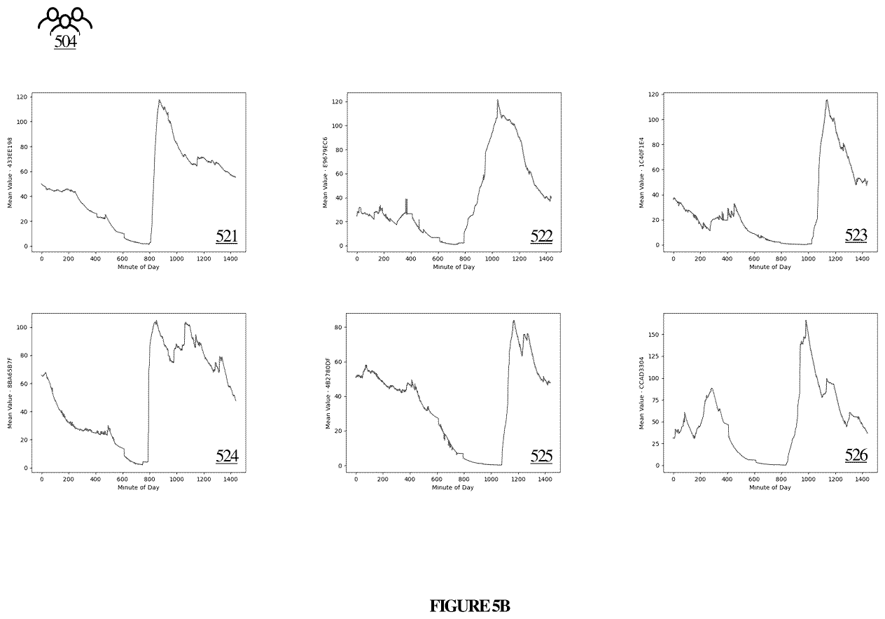

FIGS. 5A and 5B depict graphs of user activity data during various stages of processing for anomaly detection in an implementation. FIG. 5A depicts graphs 511-513 of time-aggregated user activity data of user 502 of a cloud storage environment based on telemetry data captured from a cloud storage environment in an implementation. Similarly, FIG. 5B depicts graphs 521-526 of time-aggregated user activity data of multiple users of cluster 504 (with which user 502 is associated) based on telemetry data captured for those users from the cloud storage environment in an implementation.

In FIG. 5A, graph 511 depicts the time-aggregated user activity data of user 502 aggregated by the minute over a 24-hour period (from 0 minutes to 1440 minutes). Graph 511 includes a sequence of missing data values from time 970 minutes to 1110 minutes. Graph 512 depicts the time-aggregated user activity data augmented by synthetic data. The synthetic data is generated based on the time-aggregated user activity data of users in cluster 504. Cluster 504 comprises a group of users, including user 502, who have been identified and clustered based on exhibiting behavior or activity similar to each other (for example, based on a DTW similarity scoring of user activity data and OPTICS clustering based on the similarity scores). In various implementations, the synthetic data is generated based on averaging the time-aggregated user activity data of the others for the period of time spanning 970 minutes to 1110 minutes.

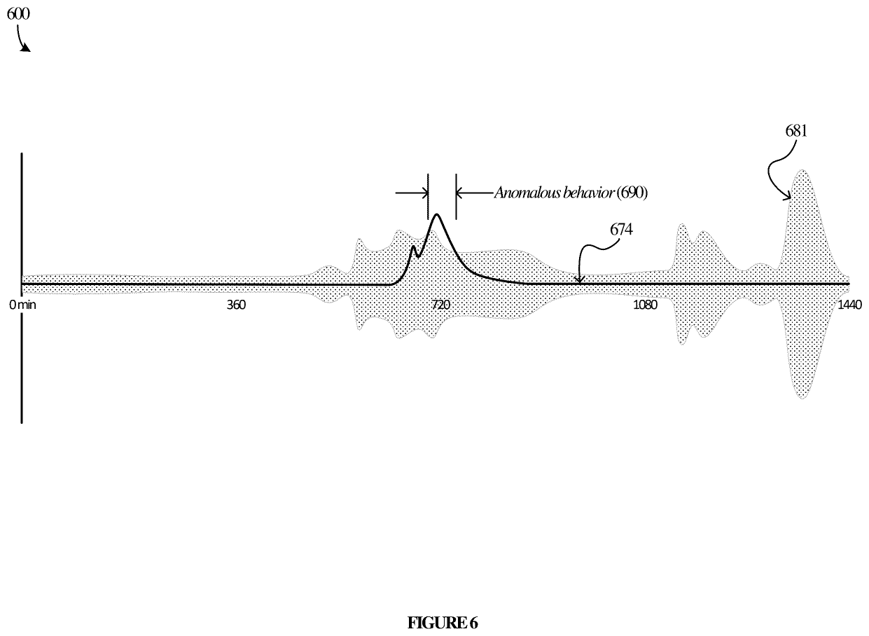

Continuing with graph 513 of FIG. 5A, the augmentation of the user activity data is smoothed to remove any abrupt jumps or transitions in the data by applying a Gaussian filter to the data values around and within the augmentation. Graph 513 is now ready for use in anomaly detection or other behavioral analysis of future activity of user 502. The augmented data of graph 513 may be included with other historical activity data for analyzing future sets of activity data for user 502. For example, the augmented data may be used in computing or updating an activity profile for user 502, such as activity profile 681 illustrated in FIG. 6 discussed below.

In FIG. 5B, graphs 521-526 depict the time-aggregated user activity data of a few of the other users in cluster 504 associated with user 502. The time-aggregated user activity data depicted in graphs 521-526 include values which were used to generate the synthetic data of graphs 512 and 513.

FIG. 6 depicts an anomaly detection process as applied to recent or incoming user activity data in an implementation of the technology disclosed herein. FIG. 6 depicts (as graphs) activity profile 681 of a given user to which incoming user activity data 674 of the given user is compared. Activity profile 681 may be generated based on computing the mean and variance of historical user activity of the given user at each point in time. Incoming user activity data 674 may be processed for anomaly detection as time-aggregated user activity data or, as depicted, as the difference between the time-aggregated data and the mean of the historical data at each point in time. Generally, when comparing an incoming user activity data set to an activity profile, data points or values falling within the bounds of the activity profile may be classified as “normal” or “non-anomalous,” while values falling outside the bounds of the activity profile (above or below) may be classified as “anomalous.” Thus, as depicted in FIG. 6, anomalous behavior 690 is identified for an interval of time during which incoming user activity data 674 exceeds the bounds of activity profile 681. In an implementation, in operation, a monitoring application, such as monitoring application 140 of FIG. 1, performing the anomaly detection flags the interval of time as anomalous (e.g., in a user interface of the application) and initiates other actions for resolving the detected anomaly.

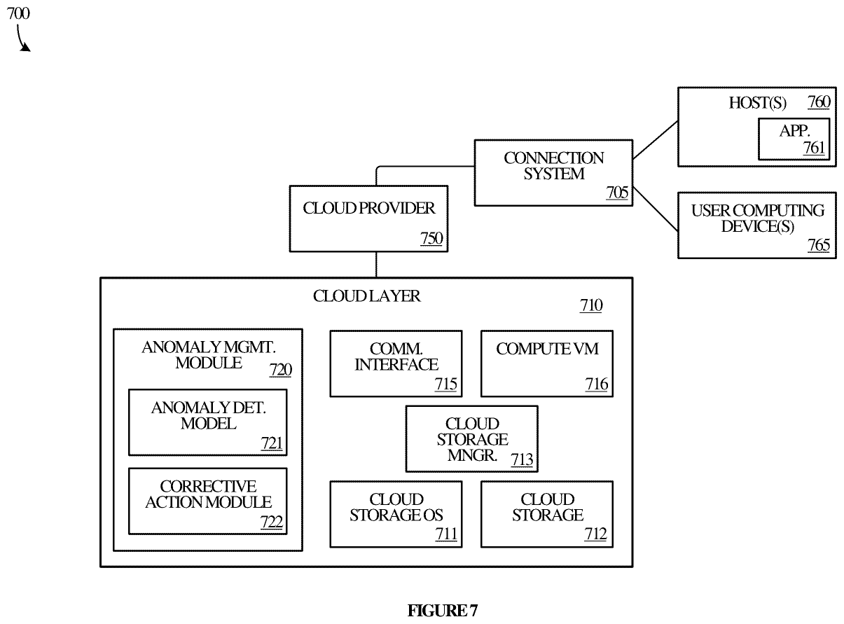

FIG. 7 illustrates an example of system 700 to implement the various adaptive aspects of the present disclosure. In an implementation, system 700 includes cloud layer 710 having a cloud storage manager 713, and cloud storage operating system (OS) 711 having access to cloud storage 712. Cloud storage manager 713 enables anomaly management.

In an implementation, anomaly management module 720 is provided to generate anomaly detection model 721 (“model 721”) for anomaly detection according to the technology disclosed herein. At a high level, model 721 detects anomalies within system 700. The term “anomaly” as used herein includes a data breach, security breach, cyberattack, software defect, or other unexpected behavior which is symptomatic of an issue creating a risk to the security or continuing operation of system 700. Model 721 includes data relating to user activity in system 700, such as historical usage patterns or data. Based on the identified anomalies, corrective action module 722 initiates a corrective action to resolve or address the anomaly. The type of corrective action depends on the type of anomaly. For example, if the anomaly is a security breach, corrective action module 722 may automatically initiate siloing or lock down of the affected systems of system 700.

As an example, cloud provider 750 provides access to cloud layer 710 and its components via communication interface 715. A non-limiting example of cloud layer 710 is a cloud platform, e.g., Amazon Web Services (“AWS”) provided by Amazon Inc., Azure provided by Microsoft Corporation, Google Cloud Platform provided by Alphabet Inc. (without derogation of any trademark rights of Amazon Inc., Microsoft Corporation or Alphabet Inc.), or any other cloud platform. In an implementation, communication interface 715 includes hardware, circuitry, logic and firmware to receive and transmit information using one or more protocols.

In an implementation, cloud storage manager 713 is provided as a software application running on a computing device or within a virtual machine (VM) for configuring, protecting, and managing storage objects. In an implementation, cloud storage manager 713 enables access to a storage service (e.g., backup, restore, cloning or any other storage related service) from a micro-service made available from cloud layer 710. The term “micro-service” as used herein denotes computing technology for providing a specific functionality in system 700 including access to storage via cloud layer 710. In an implementation, cloud storage manager 713 stores user information including a user identifier, a network domain for a user device, a user account identifier, or any other information to enable access to storage from cloud layer 710. Software applications for cloud-based systems are typically built using “containers” (e.g., Kubernetes containers). In some scenarios, anomaly management module 720 may run within cloud storage manager 713.

An example of cloud storage OS 711 includes the “CLOUD VOLUMES ONTAP” software provided by NetApp Inc., the assignee of this application (without derogation of any trademark rights). Cloud storage OS 711 is a software defined version of a storage operating system executed within cloud layer 710 to provide storage and storage management options for storage system 712. Cloud storage OS 711 has access to cloud storage 712, which may include block-based, persistent storage that is local to the cloud storage OS 711 and object-based storage that may be remote to cloud storage OS 711.

System 700 may also include host(s) 760 (or “host system(s) 760”) representative of one or more computing systems communicably coupled to cloud provider 750 and cloud layer 710 via the connection system 705 such as a local area network (LAN), wide area network (WAN), the Internet and others. As described herein, the term “communicably coupled” may refer to a direct connection, a network connection, or other connections to provide data-access service to client systems such as user consoles or user computing device(s) 765. User computing device(s) 765 are representative of computing devices that can access storage space from the cloud layer 710 presented by the cloud provider 750 or any other entity.

In an implementation, host(s) 760 of system 700 are configured to execute a plurality of processor-executable applications 761, for example, a database application, an email server, and others. These applications may be executed in different operating environments, for example, a virtual machine environment, Windows, Solaris, Unix (without derogation of any third-party rights) and others. Applications 761 may use cloud storage 712 to store information. Although host(s) 760 are shown as stand-alone computing devices, they may be made available from the cloud layer 710 as compute nodes executing applications 761 within VMs (shown as compute VM 716).

In a typical mode of operation, one or more input/output (I/O) requests are sent over connection system 705 to cloud storage OS 711 based on the request. Cloud storage OS 711 receives the I/O requests, issues one or more I/O commands to cloud storage 712 to read or write data on behalf of the host system(s) 760 and issues a response containing the requested data over connection system 705 to the respective host system(s) 760.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices.

Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803 (which may be different from a cloud storage environment producing telemetry data for anomaly management process 806). Software 805 includes and implements anomaly management process 806, which is (are) representative of the anomaly management processes discussed with respect to the preceding Figures, such as processes 200 and 220 and workflows 400 and 410. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including anomaly management process 806) may be implemented in program instructions and among other functions may, when executed by processing system 802, direct processing system 802 to operate as described with respect to the various operational scenarios, sequences, and processes illustrated herein. For example, software 805 may include program instructions for implementing anomaly management process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support anomaly management processes in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
detect a sequence of missing data in telemetry data associated with a given user of a data storage environment;
verify the given user was active during a time period of the sequence of missing data by detecting user activity associated with the given user in a different set of telemetry data;
determine, based on the detected user activity, that the sequence of missing data corresponds to a telemetry data collection failure;
upon verification, generate synthetic data to replace the sequence of missing data, wherein the synthetic data is based on activity data of users similar to the given user;
generate augmented data with the telemetry data and the synthetic data;
incorporate the augmented data into a historical user activity profile providing an indication of expected user behavior;
detect anomalous behavior in the data storage environment based on a comparison of new telemetry data with the historical user activity profile; and
take automated corrective action associated with the anomalous behavior.

2. The computing apparatus of claim 1, wherein the program instructions further direct the computing apparatus to identify the users similar to the given user based on historical user activity of the given user and other users of the data storage environment.

3. The computing apparatus of claim 2, wherein to identify the users similar to the given user, the program instructions direct the computing apparatus to:
compute similarity metrics for the historical user activity of the given user and historical user activity of the other users based on Dynamic Time Warping; and
identify the users similar to the given user based on the similarity metrics.

4. The computing apparatus of claim 1, wherein to generate the synthetic data to replace the sequence of missing data, the program instructions direct the computing apparatus to compute averages of data values of the activity data of the users similar to the given user for the time period of the sequence of missing data.

5. The computing apparatus of claim 1, wherein to detect the anomalous behavior in the data storage environment, the program instructions direct the computing apparatus to identify one or more data points of the new telemetry data which exceed a variance, wherein the variance is based on the historical user activity of the given user.

6. The computing apparatus of claim 1, wherein the program instructions further direct the computing apparatus to augment the telemetry data with the synthetic data by replacing the sequence of missing data values with corresponding values from the synthetic data.

7. The computing apparatus of claim 1, wherein to generate the synthetic data to replace the sequence of missing data, the program instructions further direct the computing apparatus to generate the synthetic data for a temporal duration that corresponds to the time period of the sequence of missing data in the telemetry data.

8. The computing apparatus of claim 1, wherein to incorporate the augmented data into the historical user activity profile, the program instructions further direct the computing apparatus to apply a smoothing operation to at least a portion of the synthetic data at boundaries between the sequence of missing data and non-synthetic telemetry data.

9. A method executed by one or more processors, comprising:
detecting a sequence of missing data in telemetry data associated with a given user of a data storage environment;
verifying the given user was active during a time period of the sequence of missing data by detecting user activity associated with the given user in a different set of telemetry data;
determining, based on the detected user activity, that the sequence of missing data corresponds to a telemetry data collection failure;
upon verification, generating synthetic data to replace the sequence of missing data, wherein the synthetic data is based on activity data of users similar to the given user;
generating augmented data with the telemetry data and the synthetic data;
incorporating the augmented data into a historical user activity profile providing an indication of expected user behavior;
detecting anomalous behavior in the data storage environment based on a comparison of new telemetry data with the historical user activity profile; and
taking automated corrective action associated with the anomalous behavior.

10. The method of claim 9, further comprising identifying the users similar to the given user based on historical user activity of the given user and other users of the data storage environment.

11. The method of claim 10, wherein identifying the users similar to the given user comprises:
computing similarity metrics for the historical user activity of the given user and historical user activity of the other users based on Dynamic Time Warping; and
identifying the users similar to the given user based on the similarity metrics.

12. The method of claim 9, wherein generating the synthetic data to replace the sequence of missing data comprises computing averages of data values of the activity data of the users similar to the given user for the time period of the sequence of missing data.

13. The method of claim 9, wherein detecting the anomalous behavior in the data storage environment based on the comparison of the new telemetry data with the historical user activity profile comprises identifying one or more data points of the new telemetry data which exceed a variance, wherein the variance is based on the historical user activity of the given user.

14. The method of claim 9, further comprising augmenting the telemetry data with the synthetic data by replacing the sequence of missing data values with corresponding values from the synthetic data.

15. The method of claim 9, wherein to generate the synthetic data to replace the sequence of missing data, the program instructions further direct the computing apparatus to generate the synthetic data for a temporal duration that corresponds to the time period of the sequence of missing data in the telemetry data.

16. The method of claim 9, wherein incorporating the augmented data into the historical user activity profile comprises applying a smoothing operation to at least a portion of the synthetic data at boundaries between the sequence of missing data and non-synthetic telemetry data.

17. One or more computer readable storage media having program instructions stored thereon that, when executed by one or more processors, direct a computing apparatus to at least:
detect a sequence of missing data in user activity data associated with a given user of a cloud storage environment;
verify the given user was active during a time period of the sequence of missing data by detecting user activity associated with the given user in a different set of telemetry data;
determine, based on the detected user activity, that the sequence of missing data corresponds to a telemetry data collection failure;
upon verification, generate synthetic data to replace the sequence of missing data, wherein the synthetic data is based on activity data of users similar to the given user;
generate augmented data with the user activity data and the synthetic data;
incorporate the augmented data into a historical user activity profile providing an indication of expected user behavior;
detect anomalous behavior in the cloud storage environment based on a comparison of new telemetry data with the historical user activity profile; and
take automated corrective action associated with the anomalous behavior.

18. The one or more computer readable storage media of claim 17, wherein the program instructions further direct the computing apparatus to identify the users similar to the given user based on historical user activity of the given user and other users of the cloud storage environment.

19. The one or more computer readable storage media of claim 18, wherein to identify the users similar to the given user, the program instructions direct the computing apparatus to:
compute similarity metrics for the historical user activity of the given user and historical user activity of the other users based on Dynamic Time Warping; and
identify the users similar to the given user based on the similarity metrics.

20. The one or more computer readable storage media of claim 17, wherein to generate the synthetic data to replace the sequence of missing data, the program instructions direct the computing apparatus to compute averages of data values of the activity data of the users similar to the given user for the time period of the sequence of missing data.
